(19) United States
(12) Patent Application Publication
(10) Pub. No.: US 2011/0096545 A1
(43) Pub. Date: Apr. 28, 2011

(54) LED LIGHTING BAR

(76) Inventor: Chia-Hao CHANG, Shulin City (TW)

(21) Appl. No.: 12/905,123

(22) Filed: Oct. 15, 2010

(30) Foreign Application Priority Data
Oct. 22, 2009 (TW) 098219524

(51) Int. Cl. F21S 4/00

(52) U.S. Cl. 362/249.02

(57) ABSTRACT

The LED lighting bar includes a first conductive wire (10), a second conductive wire (20) parallel to the first conductive wire (10), an insulator (30), at least one LED (40) and a fixing frame (50, 50′). The insulator (30) has an upper layer (31, 31′) and a lower layer (32, 32′), which cover the first conductive wire (10) and the second conductive wire (20), wherein the upper layer (31, 31′) is provided with a penetrating trough (310, 310′) for exposing a first connecting section (11) of the first conductive wire (10) and a second connecting section (21) of the second conductive wire (20). The at least one LED (40) electrically connects on a first electrode (41) of the first connecting section (11) and a second electrode (42) of the second connecting section (21). The fixing frame (50, 50′) is around the at least one LED (40) for fastening.

### BACKGROUND OF THE INVENTION

1. Technical Field

The invention relates to lighting devices, particularly to LED lighting bars.

2. Related Art

Because light emitting diodes (LEDs) feature low power consumption, long durability, small volume and quick response, they are replacing conventional bulbs in various lighting devices such as decorative lighting bars.

A typically conventional LED lighting bar is disclosed in Taiwan patent No. M316972 (hereinafter “TW972”). TW972 includes an inner fixing seat, an LED string and an outer fixing body. The LED string is composed of LED units, a wire set and a flexible circuit board. The LED string is inserted into the inner fixing seat, and the outer fixing body covers the inner fixing seat and LED string to form an integrated lighting bar.

In the structure of TW972, the LED must be soldered on the flexible circuit board first, and the outer fixing body and inner fixing seat are assembled by an extrusion process to sheathe the LED string. Thus, this assembling and manufacturing process is complicated and time-consuming. Moreover, the LEDs and their electric connection tend to be damaged because of pressure. And the damaged LEDs accommodated in the fixing body are difficult to be repaired. As a result, the yield rate of the LED string is not good enough and the costs of the LED string are too high.

### SUMMARY OF THE INVENTION

A primary object of the invention is to provide an LED lighting bar which can simplify the connection and fixation of lighting bars.

A secondary object of the invention is to provide an LED lighting bar which can efficiently reduce the costs of lighting bars.

To accomplish the above objects, the LED lighting bar of the invention includes a first conductive wire, a second conductive wire parallel to the first conductive wire; an insulator; at least one LED and a fixing frame. The insulator has an upper layer and a lower layer, which cover the first conductive wire and the second conductive wire, wherein the upper layer is provided with a penetrating trough for exposing a first connecting section of the first conductive wire and a second connecting section of the second conductive wire. The at least one LED electrically connects on a first electrode of the first connecting section and a second electrode of the second connecting section. The fixing frame is around the at least one LED for fastening.

In comparison with the conventional LED lighting bars, the upper layer of the insulator of the invention is provided with a penetrating trough to expose the first and second connecting section. The LED is placed on the first and second connecting section and is fastened by the fixing frame. Because the LED is mounted on the insulator by the fixing frame, the complicated soldering and extrusion process can be retrenched. Thus the connection and fixation of the LED is simplified.

### BRIEF DESCRIPTION OF THE DRAWINGS

FIG. 1 is a perspective view of the LED lighting bar;

FIG. 2 is an exploded perspective view of the insulator and wires;

FIG. 3 is an exploded perspective view of the LED lighting bar;

FIG. 4 is an assembled schematic view of the LED lighting bar;

FIG. 5 is a cross-sectional view of the LED lighting bar;

FIG. 6 is a schematic view of an application of the invention;

FIG. 7 shows the second embodiment of the invention; and

FIG. 8 shows the third embodiment of the invention.

### DETAILED DESCRIPTION OF THE INVENTION

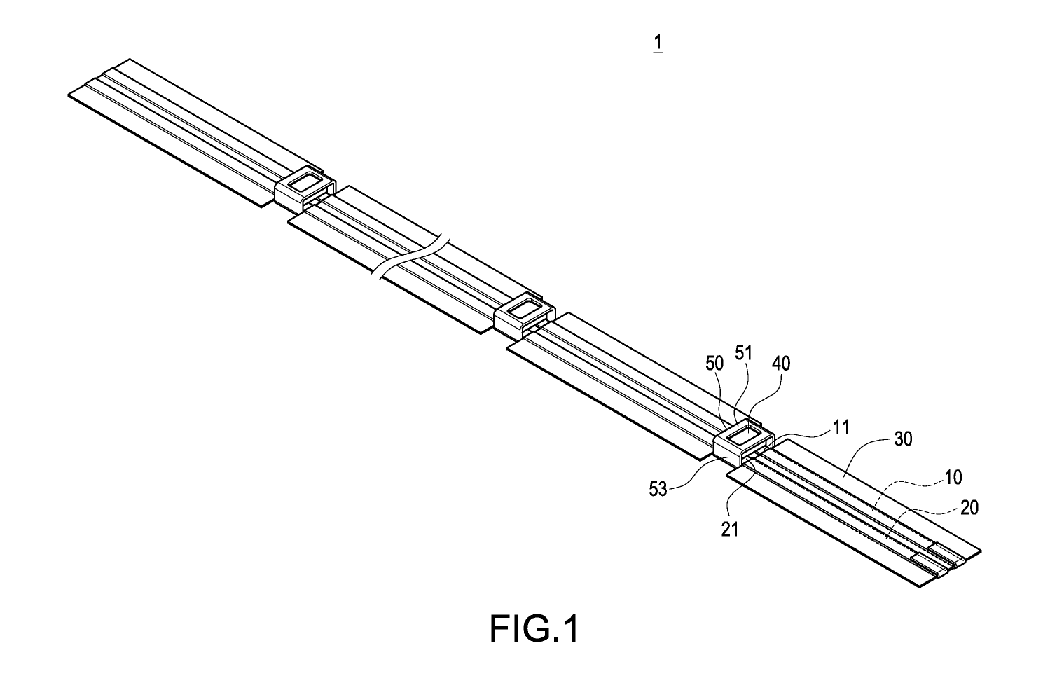

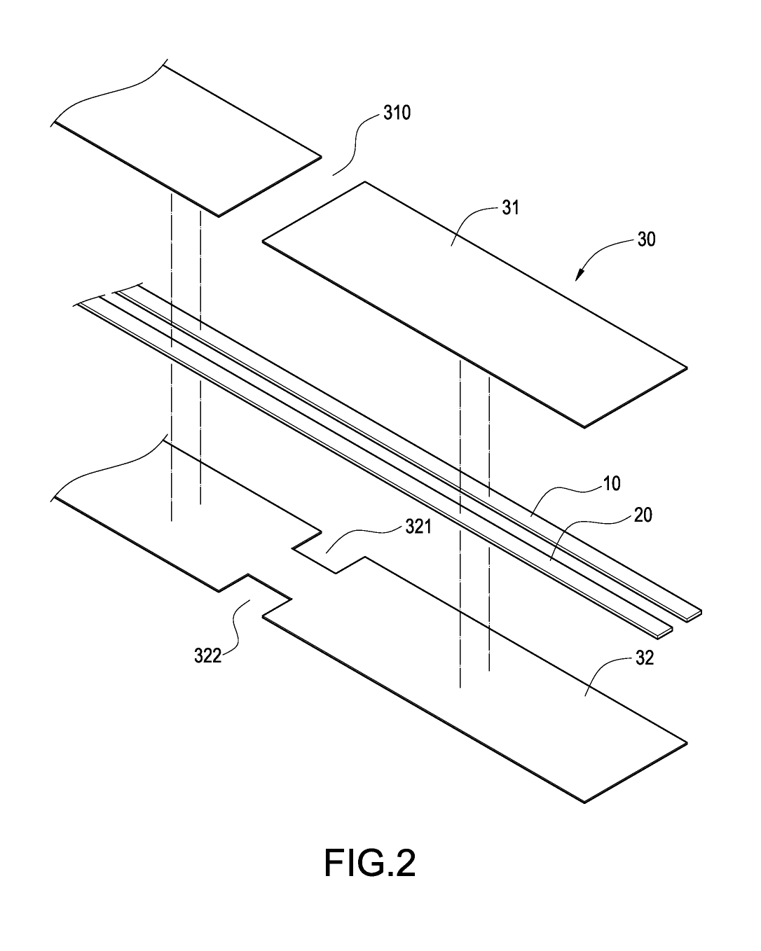

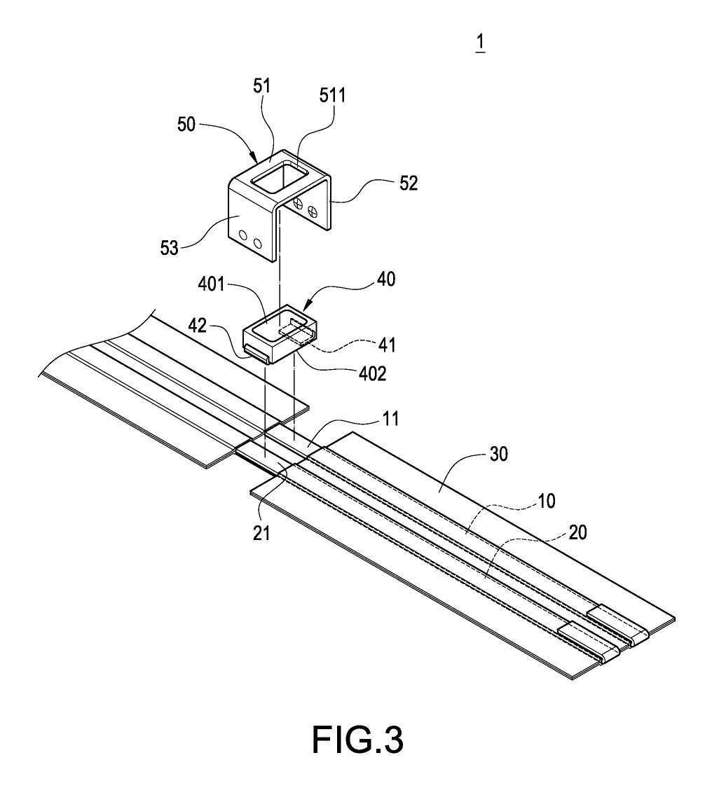

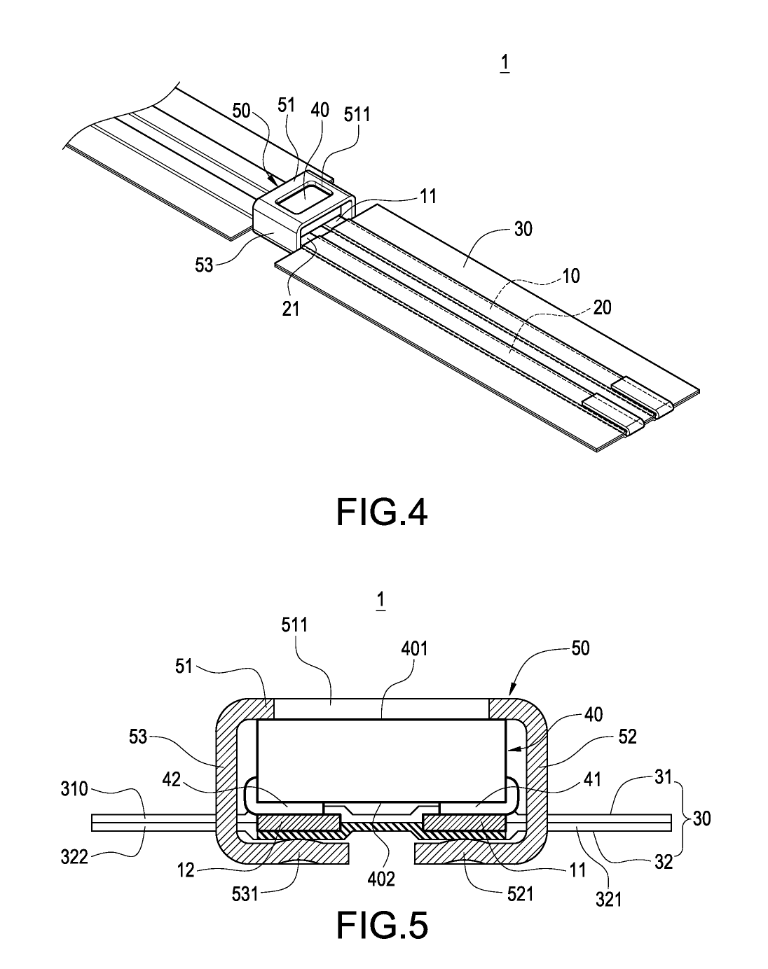

FIGS. 1-4 are an assembled perspective view, an exploded perspective view of the insulator and wires, an exploded perspective view of the LED lighting bar and an assembled perspective view, respectively. The lighting bar 1 of the invention includes a first conductive wire 10, a second conductive wire 20, an insulator 30, an LED 40 and a fixing frame 50.

The second conductive wire 20 is parallelly arranged at a lateral side of the first conductive wire 10. The insulator 30 has an upper layer 31 and a lower layer 32, which cover the first conductive wire 10 and the second conductive wire 20. The upper layer 31 is provided with a penetrating trough 310 for exposing a first connecting section 11 of the first conductive wire 10 and a second connecting section 21 of the second conductive wire 20. In the shown embodiment, the insulator 30 is made of plastic material. Two opposite sides of the lower layer 32 are separately provided with two slots 321, 322 corresponding to the first connecting section 11 and second connecting section 21. The slots 321, 322 are arranged for being mounted by the fixing frame 50.

The LED 40 is of an SMD type, and has a lighting side 401, a back side 402, a first electrode 41 and a second electrode 42. The LED 40 is mounted on the first connecting section 11 and the second connecting section 21, and the first electrode 41 and the second electrode 42 are electrically connected to the first connecting section 11 and the second connecting section 21, respectively. In other words, the LED 40 electrically connects to the first conductive wire 10 and the second conductive wire 20.

Please refer to FIG. 5. The fixing frame 50 is made of metal and includes a fixing plate 51 and two side plates 52, 53 parallelly extending from two sides of the fixing plate 51. The fixing plate 51 is provided with an opening 511 corresponding to the lighting side 401 of the LED 40. And two blocking sheets 521, 531 separately inwards extend from the side plates 52, 53. The blocking sheets 521, 531 are leaned against by the back side 402 of the LED 40 so that LED 40 is encompassed by the fixing frame 50. Thus the fixing frame 50 with the LED 40 is fixed on the insulator 30.

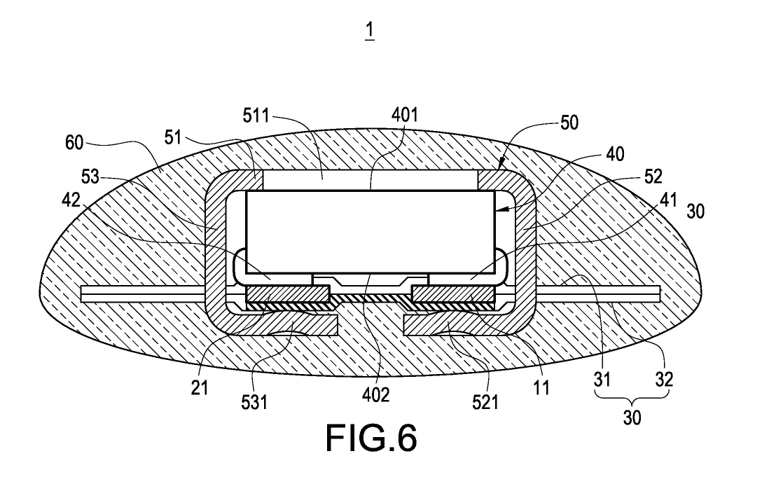

Please refer to FIG. 6, which shows a schematic view of an application of the invention. The lighting bar 1 further includes a light-permeable body 60 made of light-permeable epoxy resin. The light-permeable body 60 sheathes the LED 40 and fixing frame 50 for providing the LED 40 a protective function of water-resistance and insulation.

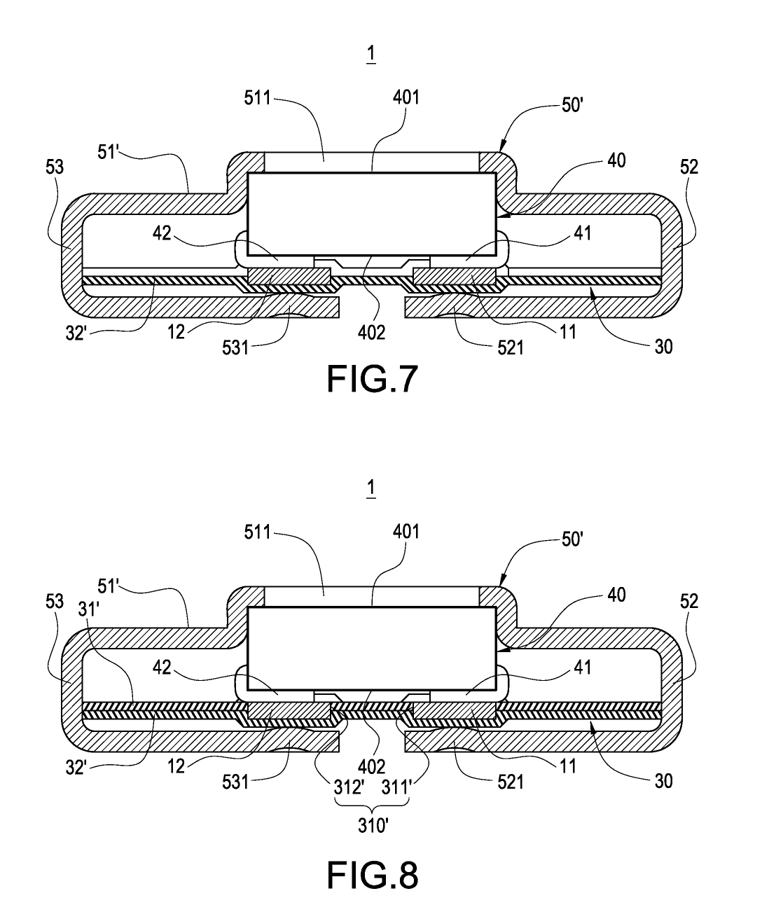

FIG. 7 shows the second embodiment of the invention. In this embodiment, the lower layer 32′ is not provided with slots. Hence, the width of the fixing plate 51′ must match that of the insulator 30 for making the fixing frame 50′ mounted on the insulator 30.

FIG. 8 shows the third embodiment of the invention. In this embodiment, the penetrating trough 310′ of the upper layer 31′ includes a first penetrating trough 311′ and a second penetrating trough 312′. The first penetrating trough 311′ and the second penetrating trough 312′ are corresponding to the first connecting section 11 and the second connecting section 21, respectively.

While the forgoing is directed to preferred embodiments of the present invention, other and further embodiments of the invention may be devised without departing from the basic scope thereof. As such, the appropriate scope of the invention is to be determined according to the claims.

What is claimed is:

1. A light emitting diode (LED) lighting bar comprising:
a first conductive wire (10);
a second conductive wire (20) parallel to the first conductive wire (10);
an insulator (30) having an upper layer (31, 31′) and a lower layer (32, 32′), which cover the first conductive wire (10) and the second conductive wire (20), wherein the upper layer (31, 31′) is provided with a penetrating trough (310, 310′) for exposing a first connecting section (11) of the first conductive wire (10) and a second connecting section (21) of the second conductive wire (20);
at least one LED (40) electrically connected on a first electrode (41) of the first connecting section (11) and a second electrode (42) of the second connecting section (21); and
a fixing frame (50, 50′) around the at least one LED (40) for fastening.

2. The LED lighting bar of claim 1, wherein the insulator (30) is made of plastic material.

3. The LED lighting bar of claim 1, wherein the penetrating trough (310′) of the upper layer (31′) further comprises a first penetrating trough (311′) and a second penetrating trough (312′), and the first penetrating trough (311′) and the second penetrating trough (312′) are corresponding to the first connecting section (11) and the second connecting section (21), respectively.

4. The LED lighting bar of claim 1, wherein two opposite sides of the lower layer (32) are separately provided with two slots (321, 322) corresponding to the first connecting section (11) and the second connecting section (21).

5. The LED lighting bar of claim 1, wherein the LED (40) is of an SMD type.

6. The LED lighting bar of claim 1, wherein the fixing frame (40) is made of metal.

7. The LED lighting bar of claim 1, wherein the LED (40) has a lighting side (401) and a back side (402), the fixing frame (50) further includes a fixing plate (51) and two side plates (52, 53) parallelly extending from two sides of the fixing plate (51), the fixing plate (51) is provided with an opening (511) corresponding to the lighting side (401), two blocking sheets (521, 531) separately inwards extend from the side plates (52, 53), and the blocking sheets (521, 531) are leaned against by the back side (402) of the LED (408).

8. The LED lighting bar of claim 1, further comprising a light-permeable body (60) sheathing the LED (40) and the fixing frame (50).

9. The LED lighting bar of claim 8, wherein the light-permeable body (60) is made of light-permeable epoxy resin.
